(19) United States
(12) Patent Application Publication
(10) Pub. No.: US 2014/0352797 A1
(43) Pub. Date: Dec. 4, 2014

(54) AIRCRAFT JET ENGINE

(71) Applicant: Rohr, Inc., Chula Vista, CA (US)

(72) Inventors: Michael Aten, San Diego, CA (US); Aleksandar Ratajac, San Diego, CA (US)

(21) Appl. No.: 13/909,772

(22) Filed: Jun. 4, 2013

(51) Int. Cl. F02C 7/04; B23P 15/00

(52) U.S. Cl. CPC F02C 7/04; B23P 15/008
USPC 137/15.1; 29/890.01

(57) ABSTRACT

In various embodiments, a jet engine, as described herein, may include a fan case, a fan cowl, and an air inlet. Further, in various embodiments, at least one of the fan case and the fan cowl may be directly coupled to the air inlet. In addition, in various embodiments, the fan case, the fan cowl, and the air inlet may be manufactured as a single, unitary, engine part.

### FIELD

The present disclosure relates to gas engine turbines, and more particularly, to turbofan jet engines having air inlets coupled directly to their respective fan cases.

### BACKGROUND

Jet powered aircraft often include turbofan engines. Turbofan engines typically incorporate a large fan mounted towards the forward portion of the engine as well as an air inlet. The air inlet may, in many instances, channel air to the fan.

### SUMMARY

In various embodiments, a jet engine may comprise a fan case, a fan cowl coupled to the fan case, and an air inlet coupled directly to at least one of the fan case and the fan cowl. Further, in various embodiments, the fan case, the fan cowl, and the air inlet may be manufactured as a single engine part. Thus, in various embodiments, the fan case and/or the fan cowl may not be coupled to the air inlet by way of a coupling member, such as a flange or A-flange. Further still, in various embodiments the jet engine may comprise an acoustic structure disposed between at least one of the fan case and/or the fan cowl and the air inlet and/or over a region that joins the fan case and/or the fan cowl to the air inlet.

In various embodiments, a jet engine may comprise an air inlet, a fan case, and a fan cowl, and these components may be manufactured as a single, unitary, jet engine part. In addition, in various embodiments, the air inlet may be coupled directly to at least one of the fan case and the fan cowl. Further, the jet engine may comprise an acoustic structure disposed between at least one of the fan case and/or the fan cowl and the air inlet and/or over a region that joins the fan case and/or the fan cowl to the air inlet. In various embodiments, at least one of the fan case and the fan cowl may not be coupled to the air inlet using a coupling member.

In various embodiments, a method for coupling an air inlet to at least one of a fan case and a fan cowl may comprise manufacturing the air inlet, the fan case, and the fan cowl as a single jet engine part, such that the fan case and/or the fan cowl are not coupled to the air inlet by way of a coupling member, such as a flange. In addition, in various embodiments, the method may comprise including an acoustic structure between the fan case and the air inlet and/or within a region that joins the fan cowl to the air inlet. In various embodiments, the acoustic structure may comprise a honeycomb shaped structure capable of absorbing noise produced by a jet engine.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates, in accordance with various embodiments, a perspective view of an aircraft jet engine.

FIG. 2 illustrates, in accordance with various embodiments, a cross-sectional view of an aircraft jet engine having an air inlet coupled directly to a fan case portion of the engine.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “aft” refers to the direction associated with the tail (e.g., the back end) of an aircraft, or generally, to the direction of exhaust of the gas turbine. As used herein, “forward” refers to the directed associated with the nose (e.g., the front end) of an aircraft, or generally, to the direction of flight or motion.

In various embodiments, an aircraft jet engine may comprise a compressor, a combustion area, and a plurality of turbines. The compressor may be mounted toward a forward portion of the engine, while the combustion area may be centrally mounted within the engine, and the plurality of turbines may comprise an aft portion of the engine. The compressor may, in various embodiments, be coupled to the turbines by way of a central shaft.

The engine may further comprise a fan case and/or a fan cowl. The fan case may surround and protect the compressor, combustion area, and turbines. Similarly, the fan cowl may surround and protect the fan ease. In addition, the fan cowl may comprise an aerodynamic shape which may aid the aircraft during flight.

In various embodiments, and with respect to turbofan engines in particular, a large fan or turbofan may be situated forward of the compressor. The fan may turn based upon energy derived from the turbines and may force a large amount of air (“bypass air”) over the compressor, combustion area, and/or turbines to boost the power output by the turbines. In addition, an air inlet (which may comprise an aerodynamic shape) may be situated forward of the turbofan to guide air into the turbofan.

The fan case and/or fan cowl may, in various embodiments, be coupled directly to the air inlet. For example, during construction of the jet engine, the fan case and/or fan cowl may be machined such that one or both of these components couples, or is capable of coupling, directly to the air inlet. Further, in various embodiments, the fan case and/or cowl 102 may be constructed, together with the air inlet 104, as a single, larger, engine part. This feature may offer a significant advantage over a variety of conventional turbofan engines, in that other engines require the use of a flange or other intermediate coupling member (e.g., an “A flange”) to join the fan case to the air inlet. In addition, construction of the engine, as described above, may offer a variety of advantages. For instance, such a construction may reduce the weight of the engine, make construction of the engine more inexpensive, make the engine more aerodynamic, aid with heat dissipation and/or reduce the heat produced by the engine, and the like.

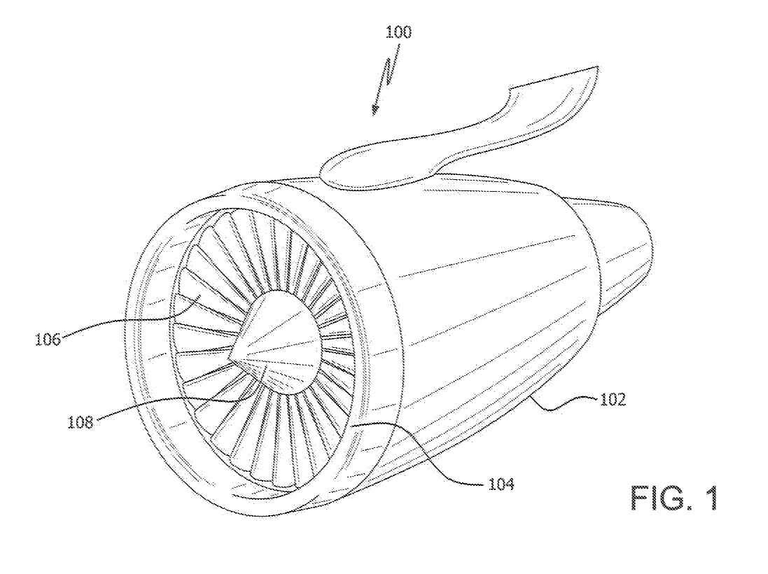

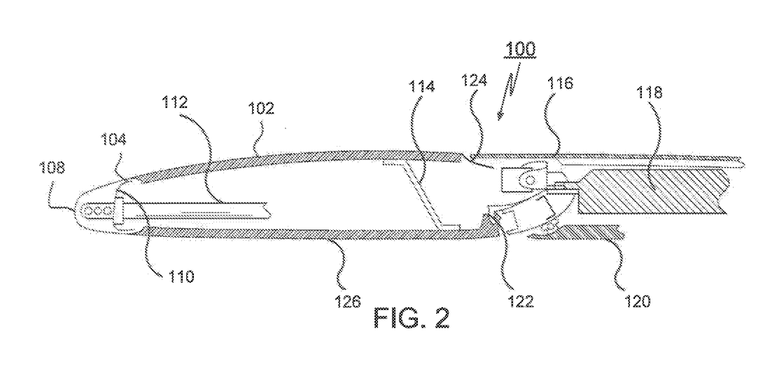

Therefore, in various embodiments, and with reference to FIGS. 1 and 2, a turbofan jet engine 100 is presented. As shown, the engine 100 may comprise a fan cowl 102, an air inlet 104, and a turbofan 106 mounted upon a central shaft. A lip skin 108 may be coupled to the central shaft and mounted forward of the turbofan 106. In addition, the engine 100 may comprise a forward bulkhead 110, an anti ice duct 112, an aft bulkhead 114, a translating sleeve 116, cascades 118, blocker doors 120, a v-blade 122, a torque box 124, and a fan case 126. The fan case 126 may enclose a plurality of fan blades.

More particularly, with reference now to FIG, 2, the fan cowl 102 and/or fan case (which may be mounted within the fan cowl 102) may be coupled directly, and without the use of a flange or other coupling member, to the air inlet 104. In various embodiments, the fan cowl 102 may be coupled to or combined with an inlet 104 outer barrel, while the fan case 126 may be coupled to or combined with an inlet 104 inner barrel. As described above, the fan case 126 and/or fan cowl 102 may be constructed, together with the air inlet 104, as a single, larger, engine part. This direct connection between the fan cowl 102 and/or fan case 126 and the air inlet 104 may, as described above, offer a significant advantage over a turbofan engine in which a coupling member (such as a flange or A-flange) is required to mount the fan case and/or fan cowl to the air inlet. A direct connection between the fan case 126 and/or fan cowl 102 and the air inlet 104 (inner and/or outer barrels) may not, in turn, require the use of components (such as for example, one or more bolts, one or more crash washers, and the like) which may be needed to couple the fan cowl 102 and/or case 126 to the air inlet 104 using a flange. Thus, a variety of components may be eliminated by coupling the fan case 126 and/or cowl 102 directly to the air inlet 104.

The removal of components that couple the fan case and/or cowl to the air inlet may simplify the construction and reliability of the engine 100. Likewise, the mass of the engine 100 may be reduced through the exclusion of these components.

In addition, in various embodiments, a jet engine 100 may comprise acoustic structures, such as noise reducing or absorbing components or treatments (e.g., one or more honeycomb structures). These treatments may be included within the engine fan case 126 and/or between the fan case 126 and the fan cowl 102 to reduce the noise produced by the engine during operation. In jet engines having coupling members to join the fan case and/or cowl to the air inlet, the use of the coupling members may prevent inclusion of any acoustic treatment in the region surrounding the coupling member (e.g., the coupling member must be mounted to a set of solid rings, the presence of which may preclude the use of an acoustic treatment). However, where the fan case 126 and/or cowl 102 are directly joined to the air inlet 104, an acoustic treatment may be applied within the region formerly occupied by the coupling member and/or the hardware accompanying the coupling member. Thus, the noise generated by an engine 100 in which the fan case 126 and/or cowl 102 are mounted directly to the air inlet 104 may be significantly dampened, particularly in comparison to the noise generated by an engine in which a coupling member is required.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more,” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment” “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic, in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A turbofan engine comprising:
a fan case;
a fan cowl coupled to the fan case; and
an air inlet coupled directly to at least one of the fan case and the fan cowl.

2. The turbofan engine of claim 1, wherein the fan case, the fan cowl, and the air inlet are manufactured as a single engine part.

3. The turbofan engine of claim 1, further comprising an acoustic structure disposed between the fan case and the air inlet.

4. The turbofan engine of claim 1, further comprising an acoustic structure disposed over a region that joins the fan case to the air inlet.

5. The turbofan engine of claim further comprising an acoustic structure disposed between the fan cowl and the air inlet.

6. The turbofan engine of claim 1, further comprising an acoustic structure disposed within a region that joins the fan cowl to the air inlet.

7. The turbofan engine of claim 1, wherein the at least one of the fan case and the fan cowl are not coupled to the air inlet using a coupling member.

8. A jet engine comprising:
an air inlet;
a fan case; and
a fan cowl, wherein the air inlet, the fan case, and the fan cowl are manufactured as a single, unitary, jet engine part.

9. The jet engine of claim 8, wherein the air inlet is coupled directly to at least one of the fan case and the fan cowl.

10. The jet engine of claim 8, further comprising an acoustic structure disposed between the fan case and the air inlet.

11. The jet engine of claim 8, further comprising an acoustic structure disposed over a region that joins the fan ease to the air inlet.

12. The jet engine of claim 8, further comprising an acoustic structure disposed between the fan cowl and the air inlet.

13. The jet engine of claim 8, further comprising an acoustic structure disposed within a region that joins the fan cowl to the air inlet.

14. The jet engine of claim 8, wherein the at least one of the fan case and the fan cowl are not coupled to the air inlet using a coupling member.

15. A method for coupling an air inlet to at least one of a fan case and a fan cowl comprising:
manufacturing the air inlet; and
manufacturing the fan case and the fan cowl, with the air inlet, as a single jet engine part.

16. The method of claim 15, further comprising disposing an acoustic structure between the fan case and the air inlet.

17. The method of claim 16, wherein the acoustic structure absorbs noise produced by a jet engine.

18. The method of claim 17, wherein the acoustic structure comprises a honeycomb shaped structure.

19. The method of claim 15, wherein the fan case and the fan cowl are not coupled to the air inlet using a coupling member.

20. The method of claim 15, further comprising including an acoustic structure disposed within a region that joins the fan cowl to the air inlet.
